(19) United States
(12) Patent Application Publication
(10) Pub. No.: US 2014/0106037 A1
(43) Pub. Date: Apr. 17, 2014

(54) FOODSTUFF TREAT MAKER WITH FORMING PLATES

(71) Applicant: SELECT BRANDS, INC., Lenexa, KS (US)

(72) Inventors: William S. Endres, Leawood, KS (US); Blaise Wooderson, Olathe, KS (US); Mark T. Krasne, Kansas City, MO (US)

(73) Assignee: SELECT BRANDS, INC., Lenexa, KS (US)

(21) Appl. No.: 13/782,428

(22) Filed: Mar. 1, 2013

Related U.S. Application Data
(60) Provisional application No. 61/715,092, filed on Oct. 17, 2012.

(51) Int. Cl. A23P 1/10

(52) U.S. Cl. CPC A23P 1/105
USPC 426/138; 99/439; 425/233

(57) ABSTRACT

A foodstuff treat maker operable to shape a foodstuff material into a shaped foodstuff treat. The foodstuff treat maker includes a pair of opposed forming plates shiftably attached relative to one another and presenting respective forming surfaces. One of the forming surfaces defines a protrusion and the other forming surface defines a cavity. The protrusion is at least partly received in the cavity in a forming position so that the pair of forming plates are mated with one another, with the mated forming surfaces cooperatively shaping foodstuff material applied thereto.

### RELATED APPLICATION

This application claims the benefit of U.S. Provisional Application Ser. No. 61/715,092, filed Oct. 17, 2012, entitled PET TREAT MAKER, which is hereby incorporated in its entirety by reference herein.

### BACKGROUND

1. Field

The present invention relates generally to a foodstuff treat maker with opposed forming plates. More specifically, embodiments of the present invention concern a biscuit making appliance with forming plates that present a protrusion and a cavity.

2. Discussion of Prior Art

Countertop baking appliances have long been used to make various foodstuff articles. Some conventional appliances generally use a pair of metal plates to shape the foodstuff articles and electrically powered heating elements to heat the plates. Such prior art appliances include waffle makers and sandwich makers.

However, prior art baking appliances suffer from various undesirable limitations. For example, conventional appliances produce foodstuff articles that are fragile and tend to come apart easily, particularly where the article comprises a homogeneous foodstuff material. At the same time, these appliances require excessive amounts of foodstuff material to make the articles.

### SUMMARY

The following brief summary is provided to indicate the nature of the subject matter disclosed herein. While certain aspects of the present invention are described below, the summary is not intended to limit the scope of the present invention.

Embodiments of the present invention provide a treat making appliance that does not suffer from the problems and limitations of the prior art appliances set forth above.

A first aspect of the present invention concerns a foodstuff biscuit maker operable to shape a foodstuff material into a shaped foodstuff biscuit. The foodstuff biscuit maker broadly includes a pair of opposed forming plates. The opposed forming plates are shiftably attached relative to one another and present respective forming surfaces. One of the forming surfaces defines a protrusion and the other of the forming surfaces defines a cavity. The forming plates are shiftable into and out of a forming position where the forming surfaces are located adjacent and in opposition to one another. The forming surfaces are shifted away from each other when the forming plates are shifted out of the forming position to expose the forming surfaces and permit the application of foodstuff material to at least one of the forming surfaces. The protrusion is at least partly received in the cavity in the forming position so that the pair of forming plates are mated with one another, with the mated forming surfaces cooperatively shaping the applied foodstuff material.

A second aspect of the present invention concerns a baked foodstuff biscuit that broadly includes a base wall and a peripheral wall. The base wall and peripheral wall are integrally formed of a foodstuff material and baked with each other to present a unitary biscuit form. The base wall extends laterally to present an outboard margin and opposite laterally extending faces that span the margin and define a transverse wall thickness dimension. The peripheral wall projects transversely from the outboard margin of the base wall so that the base wall and peripheral wall cooperatively define a transverse biscuit thickness dimension greater than the transverse wall thickness dimension. The peripheral wall extends endlessly about the base wall to present a biscuit opening, with the base wall spanning the biscuit opening so that the walls cooperatively form a receptacle opening.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is an upper front perspective of a foodstuff treat maker constructed in accordance with a preferred embodiment of the present invention, with the foodstuff treat maker including upper and lower forming plates, upper and lower housings, and upper and lower handles, and showing the treat maker open to expose a foodstuff biscuit made by the treat maker;

FIG. 2 is an upper front perspective of the foodstuff treat maker shown in FIG. 1, showing the treat maker in a closed, forming position;

FIG. 3 is a cross section of the foodstuff treat maker shown in FIGS. 1 and 2, where the cross section is taken between the forming plates when the treat maker is in the forming position, and showing protrusions of the upper forming plate received by cavities presented by the lower forming plate;

FIG. 3a is an enlarged fragmentary cross section of the foodstuff treat maker similar to FIG. 3, but showing only one of the pairs of engaged protrusions and cavities;

FIG. 4 is an enlarged fragmentary cross section of the forming plates taken along line 4-4 in FIG. 3a, with the lower forming plate including a cavity wall that presents the cavity and includes an end wall, a side wall, and a lip, and the upper forming plate including a protrusion wall that presents the protrusion and includes a base wall, an end wall, a side wall, and a lip;

FIG. 5 is an enlarged fragmentary cross section of the forming plates taken along line 5-5 in FIG. 3a;

FIG. 6 is an upper front perspective of the foodstuff treat maker similar to FIG. 1, but showing a dough blank prior to insertion into the treat maker;

FIG. 7 is an upper front perspective of the foodstuff treat maker similar to FIG. 6, but showing the dough blank inserted into the treat maker;

FIG. 8 is a cross section of the foodstuff treat maker shown in FIGS. 1-7, showing the treat maker between the open position and the forming position, with dough blank inserted into the treat maker and partly engaged by the protrusion;

FIG. 9 is a cross section of the foodstuff treat maker similar to FIG. 8, but showing the treat maker in the forming position and the dough blank engaged by the protrusion;

FIG. 10 is an upper perspective of the foodstuff biscuit shown in FIG. 1, with the foodstuff biscuit including a base wall and a peripheral wall integrally formed with each other to present a receptacle opening;

FIG. 11 is a top view of the foodstuff biscuit shown in FIGS. 1 and 10;

FIG. 12 is an upper perspective of the foodstuff biscuit shown in FIGS. 1, 10, and 11, but with foodstuff filling being added to the biscuit to provide a filled foodstuff biscuit;

FIG. 13 is a top view of the filled foodstuff biscuit shown in FIG. 12;

FIG. 14 is a cross section of the filled foodstuff biscuit taken along line 14-14 in FIG. 13; and

FIG. 15 is a cross section of the filled foodstuff biscuit taken along line 15-15 in FIG. 13.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

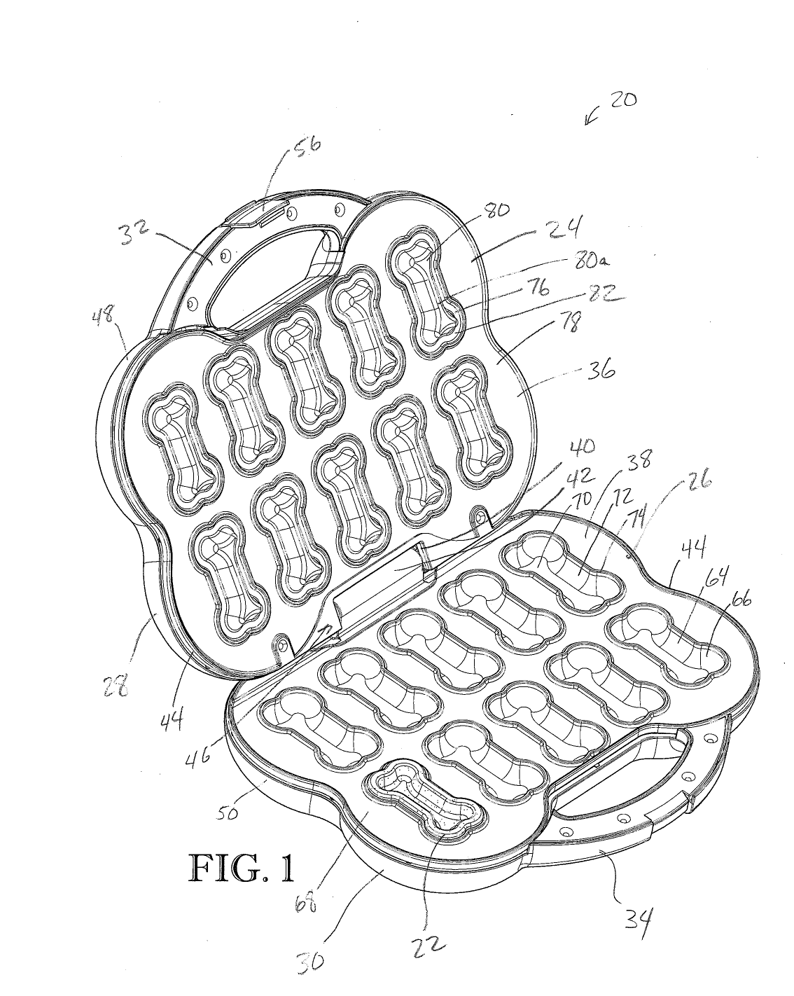

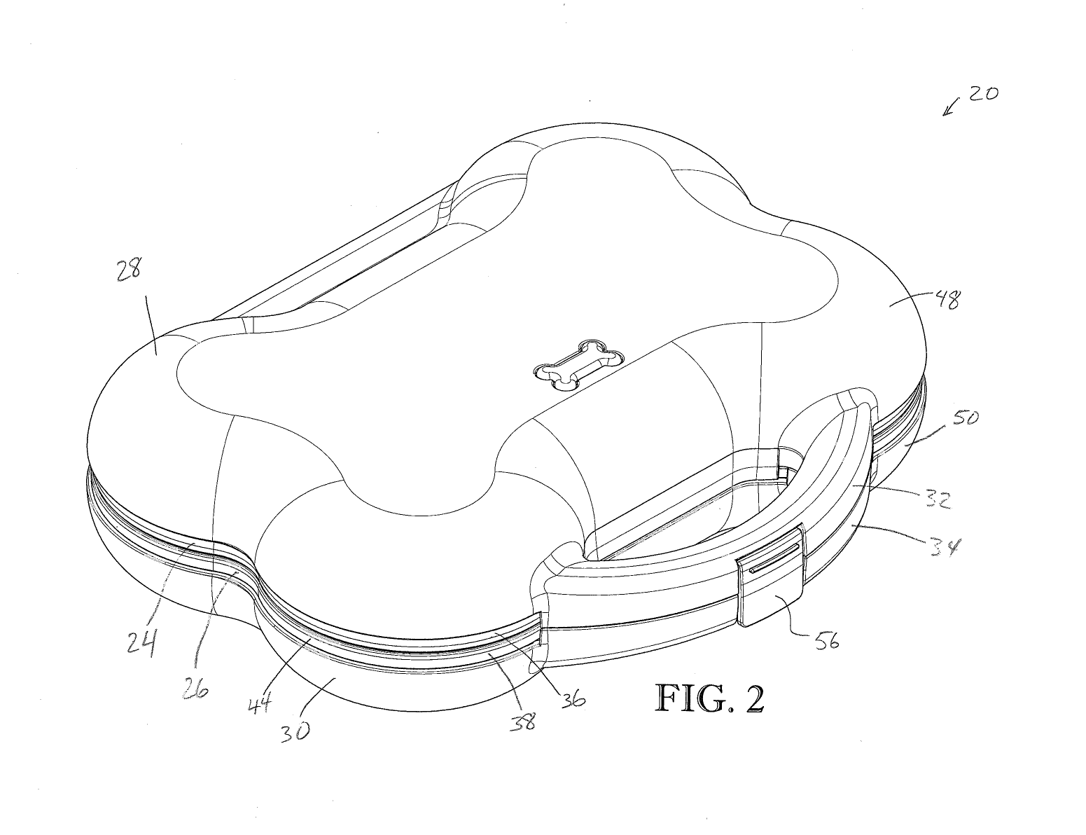

Turning initially to FIGS. 1 and 2, a foodstuff biscuit maker 20 is constructed in accordance with a preferred embodiment of the present invention. As will be discussed in greater detail, the biscuit maker 20 is preferably used to form and bake multiple foodstuff biscuits 22 for consumption by a pet, such as a dog. However, it is within the scope of the present invention where the maker 20 is foodstuff material is alternatively configured, e.g., for making biscuit treats suitable for human consumption. Also, the maker 20 could be configured to make a treat other than a biscuit. For instance, the maker 20 could be used to bake a mix of foodstuff ingredients such that the baked treat has a relatively softer and/or more flexible structure than a biscuit, e.g., such as a dessert cake. The biscuit maker 20 preferably includes upper and lower forming plates 24,26, upper and lower housings 28,30, and upper and lower handles 32,34.

Turnings to FIGS. 1, 2, 8, and 9, the forming plates 24,26 each preferably comprise unitary cast metal plates with a nonstick coating applied to the plate surfaces. The forming plates 24,26 include base plates 36,38 and hinge elements 40,42. The base plates 36,38 present an outer margin 44 that forms a rim. The hinge elements 40,42 are integrally formed with respective base plates 36,38 and are located along the outer margin 44. The hinge elements 40,42 are pivotally interconnected to form a pivot joint 46 so that the forming plates 24,26 can swing relative to one another between an open position (see FIG. 1) and a closed position, i.e., a forming position associated with forming of biscuits 22 (see FIG. 2). In the forming position, the forming surfaces of the forming plates 26 are generally in opposition to each other. As will be discussed, the forming plates 24,26 further include features that cooperatively form the biscuits 22.

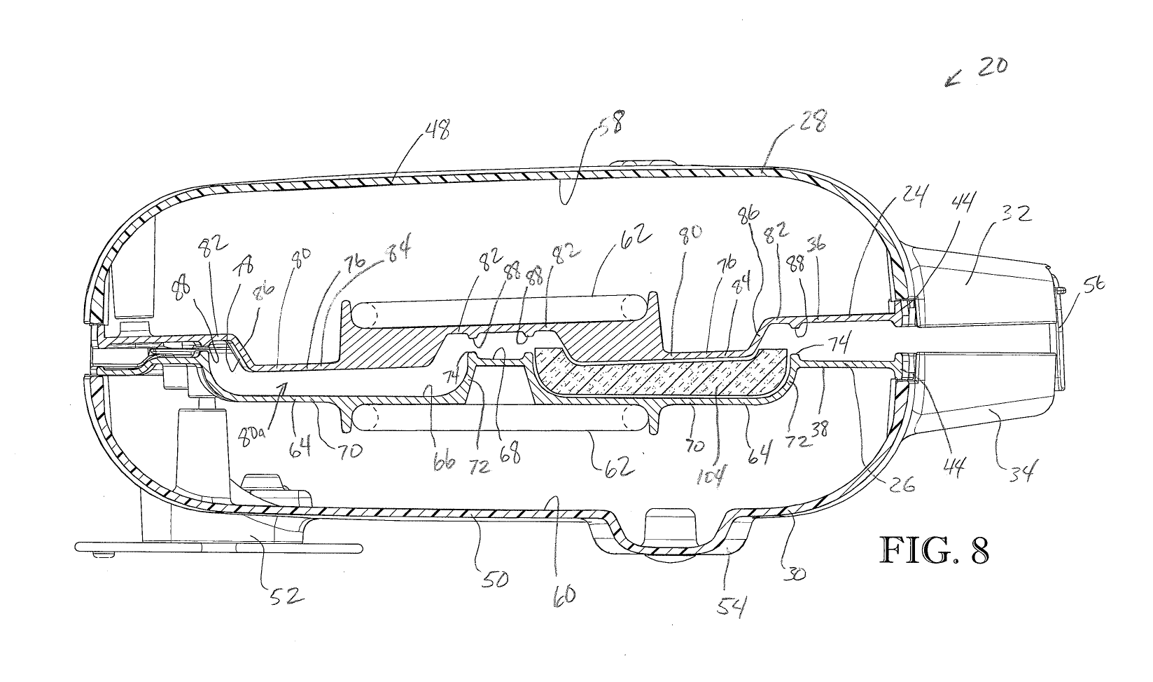

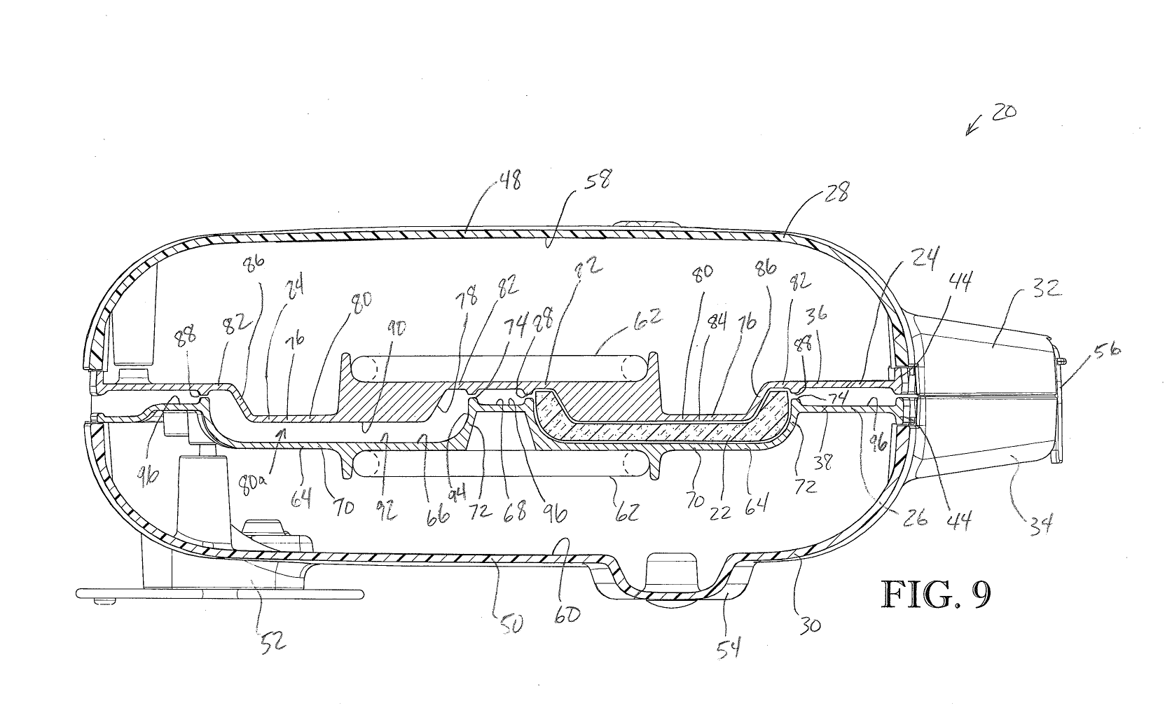

The housings 28,30 are each preferably formed of a molded synthetic resin and include an outer housing wall 48,50. The lower housing 30 also preferably includes molded feet 52,54 integrally formed with the wall 50 (see FIGS. 8 and 9). The handles 32,34 also preferably are formed of a molded synthetic resin that is integrally formed with the respective outer housing wall 48,50.

The housings 28,30 are attached to respective forming plates 24,26 with fasteners (not shown). Thus, the housings 28,30 and handles 32,34 are pivotable with respective forming plates 24,26 between the open position and the forming position associated with forming of biscuits 22.

The biscuit maker 20 also preferably includes a latch 56 pivotally attached to the upper handle 32. The latch 56 presents a latch end that is pivotal into and out latching engagement with a corresponding catch (not shown) presented the lower handle 34 when the biscuit maker 20 is shifted into the forming position. The latch 56 and catch cooperatively hold the biscuit maker 20 closed in the forming position (see FIG. 9).

Turning to FIGS. 8 and 9, the forming plates 24,26 and housings 28,30 cooperatively form respective enclosed internal chambers 58,60. The biscuit maker 20 preferably includes electric heating elements 62 mounted on respective forming plates 24,26 and located within respective chambers 58,60. In the usual manner, the heating elements 62 are operable to be coupled to an electric power source so that electric current can be passed through the heating elements 62 to generate heat suited for baking biscuits 22 between the forming plates 24,26.

As will be discussed, this heating configuration is preferred so that the biscuit maker 20 can form and bake biscuits 22 independent of a heating source. However, for some aspects of the present invention, a biscuit maker 20 could be provided without the heating elements 62. For instance, the forming plates 24,26 could be provided as part of a biscuit maker 20 that is placed in a conventional oven to bake the biscuits 22.

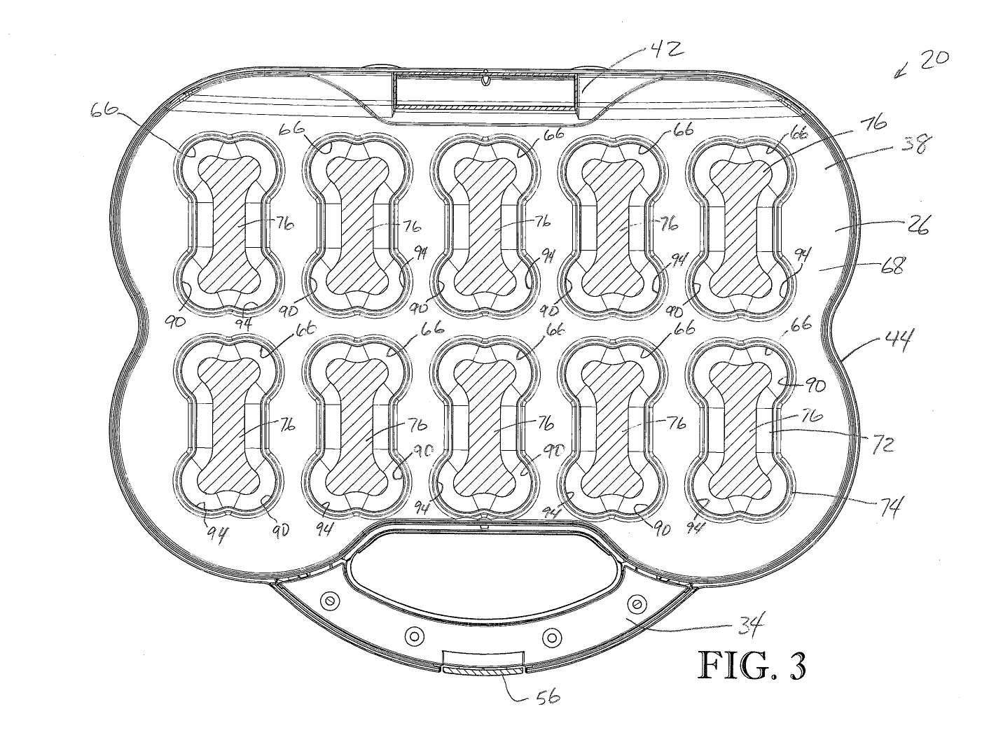

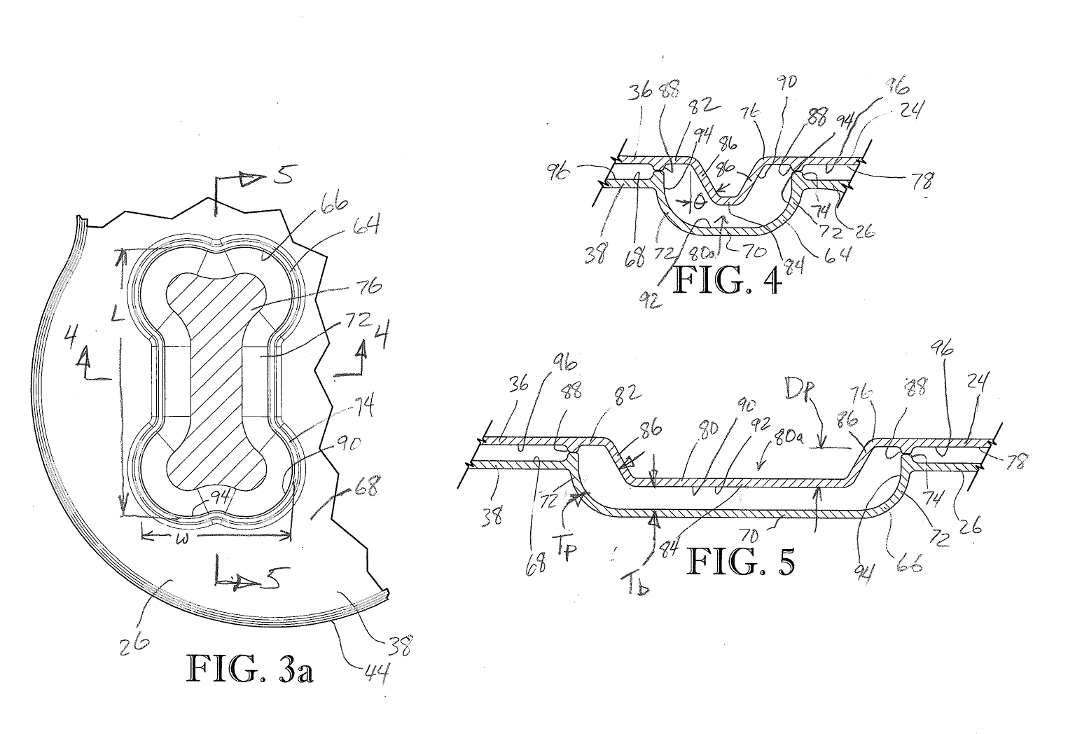

Turning to FIGS. 3-5, the lower forming plate 26 preferably includes the base plate 38 and a plurality of cavity walls 64 that each present a cavity 66. The base plate 38 and cavity walls 64 cooperatively present a lower forming surface 68. The cavity walls 64 each preferably include an end wall 70 and a side wall 72 that extends endlessly around the end wall 70 and supports the end wall 70 relative to the base plate 38. Each cavity wall 64 also presents an endless lip 74 that projects from the base plate 38 and defines an outer margin of the cavity wall 64.

The illustrated cavity wall 64 preferably forms an outline of a dog bone shape, but could present other shapes without departing from the scope of the present invention. Also, the illustrated cavity 66 could be alternatively sized. The lower forming plate 26 preferably presents ten (10) cavities 66 arranged in two rows of five cavities 66. However, the lower forming plate 26 could have an alternative number and/or arrangement of cavities 66.

The upper forming plate 24 preferably includes the base plate 36 and a plurality of protrusion walls 76. The illustrated base plate 38 and protrusion walls 76 cooperatively present an upper forming surface 78. The protrusion walls 76 each preferably include a protrusion 80 and a base wall 82 that extends endlessly around the protrusion 80 and supports the protrusion 80 relative to the base plate 36. Preferably, the protrusion 80 includes an end wall 84 that forms an end 80a of the protrusion 80 and a side wall 86 that extends endlessly around the end wall 84 and supports the end wall 84 relative to the base wall 82. Each protrusion wall 76 also preferably presents an endless lip 88 that projects from the base plate 36 and defines an outer margin of the protrusion wall 76.

The side wall 86 presents a draft angle dimension θ measured relative to the transverse direction (see FIG. 4). The illustrated draft angle dimension θ preferably ranges from about ten (10) degrees to about thirty (30) degrees and, more preferably, is about twenty (20) degrees. However, it is within the ambit of the present invention where the draft angle dimension θ falls outside of this range. Also, the draft angle dimension θ is preferably substantially continuous along the entire length of the side wall 86.

The illustrated protrusion wall 76 preferably forms an outline of a dog bone shape, but could present other shapes, without departing from the scope of the present invention. Also, the illustrated protrusion 80 could be alternatively sized. The upper forming plate 24 preferably presents ten (10) protrusions 80 arranged in two rows of five protrusions 80. However, the upper forming plate 26 could have an alternative number and/or arrangement of protrusions 80.

As will be explained in greater detail, the matable forming surfaces 68,78 are preferably pivotal into and out of the forming position to cooperatively shape the applied foodstuff material. In the forming position, the forming surfaces 68,78 are generally opposed to one another. When shifted out of the forming position, the forming surfaces 68,78 are generally shifted away from each other so that the forming surfaces 68,78 are exposed, which permits the application of foodstuff material to the forming surfaces 68,78.

In the forming position, the forming plates 24,26 are positioned so that the lips 88 defined by the upper forming plate 24 are immediately adjacent to (and in some instances contact) corresponding lips 74 defined by the lower forming plate 26. Thus, the lips 74,88 restrict movement of the forming plates 24,26 toward one another. The illustrated protrusions 80 are partly received in the cavities 66 so that the forming surfaces 68,78 of the pair of forming plates 24,26 are mated with one another.

Each mated pair of cavity and protrusion walls 64,76 preferably cooperatively define a biscuit chamber 90 in the forming position. The illustrated biscuit chamber 90 preferably extends along the protrusion 80 so that the protrusion 80 is spaced from the cavity wall 64. However, for some aspects of the present invention, the biscuit chamber 90 could be alternatively configured, e.g., where the protrusion 80 extends up to and contacts the cavity wall 64. The illustrated biscuit chamber 90 preferably presents a length L that ranges from about two (2) inches to about three (3) inches and, more preferably, is about two and one half (2.5) inches (see FIG. 3a). The illustrated biscuit chamber 90 also preferably presents a width W that ranges from about one (1) inch to about two (2) inches and, more preferably, is about one and one half (1.5) inches.

The illustrated protrusion 80 is preferably located in the forming position so that the protrusion end 80a and cavity wall 64 preferably extend laterally adjacent one another to define a laterally extending base section 92 of the biscuit chamber 90. Also, the cavity and protrusion walls 64,76 preferably form a peripheral section 94 of the chamber 90 that extends endlessly around the protrusion 80 and communicates with the base section 92 in the forming position. However, for some aspects of the present invention, the forming plates 24,26 could be constructed so that the peripheral section 94 is not endless. For instance, opposite lateral ends of the protrusion 80 (i.e., the dog bone ends in the illustrated embodiment) could extend into engagement with the cavity wall 64 in the forming position so that the forming plates 24,26 define a pair of opposite peripheral sections.

Turning to FIGS. 4 and 5, the laterally extending base section 92 defines a transverse base thickness dimension Tb in the forming position (see FIG. 5). More preferably, the protrusion end 80a and cavity wall 64 preferably cooperatively define a minimum value of the transverse base thickness dimension Tb that ranges from about one tenth (0.1) of an inch to about three tenths (0.3) of an inch. However, the principles of the present invention are applicable where the minimum value of the transverse base thickness dimension Tb is outside of this range.

The peripheral section preferably defines a transverse peripheral section thickness dimension Tp that is greater than the transverse base thickness dimension Tb (see FIG. 5). The transverse peripheral section thickness dimension Tp is generally measured transverse to the side wall 86. Preferably, the transverse peripheral section thickness dimension Tp ranges from about two tenths (0.2) of an inch to about four tenths (0.4) of an inch and, more preferably, is about three tenths (0.3) of an inch.

Turning again to FIGS. 3-5, the base plates 36,38 cooperatively define an overflow chamber 96 in the forming position. Thus, the forming plates 24,26 permit foodstuff material to flow from the biscuit chamber 90 to the overflow chamber 96 when an excess foodstuff material restricts the forming plates 24,26 from shifting into the forming position.

The base wall 82 and the protrusion end 80a cooperatively define a transverse protrusion depth dimension Dp that is greater than the transverse base thickness dimension Tb (see FIG. 5). Preferably, the protrusion depth dimension Dp ranges from about two tenths (0.2) of an inch to about four tenths (0.4) of an inch and, more preferably, is about three tenths (0.3) of an inch. Also, the maker 20 preferably defines a ratio of the transverse protrusion depth dimension Dp to the transverse base thickness dimension Tb that ranges from about 1.5:1 to about 2:1.

Again, the forming surfaces 68,78 are preferably pivotal into and out of the forming position to cooperatively shape the applied foodstuff material. However, for some aspects of the present invention, the forming surfaces 68,78 could be alternatively shifted into and out of the forming position. For instance, the forming surfaces 68,78 could translate relative to one another into and out of the forming position (e.g., where the forming surfaces 68,78 move relative to each other in a direction transverse to the base plates 36,38).

Preferably, as the forming surfaces 68,78 move out of the forming position, the protrusions 80 generally move away from the cavities 66. Respective pairs of protrusions 80 and cavities 66 are preferably aligned so that the protrusions 80 remain spaced from the cavities 66 during shifting into and out of the forming position.

The biscuit maker 20 is preferably configured to be removably latched in the forming position. In particular, the latch 56 is shifted into engagement with the lower handle 34. The latch 56 can be subsequently shifted out of engagement with the lower handle 34 so that the biscuit maker 20 can be opened to pivot the forming surfaces 68,78 out of the forming position.

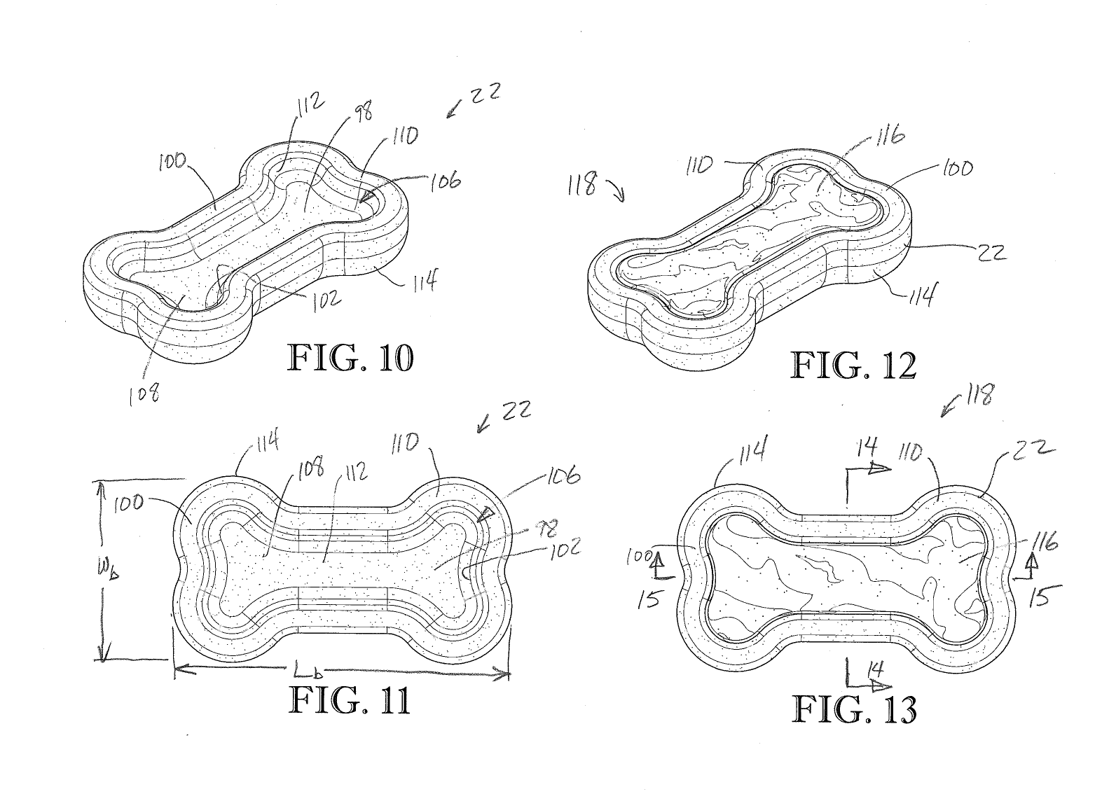

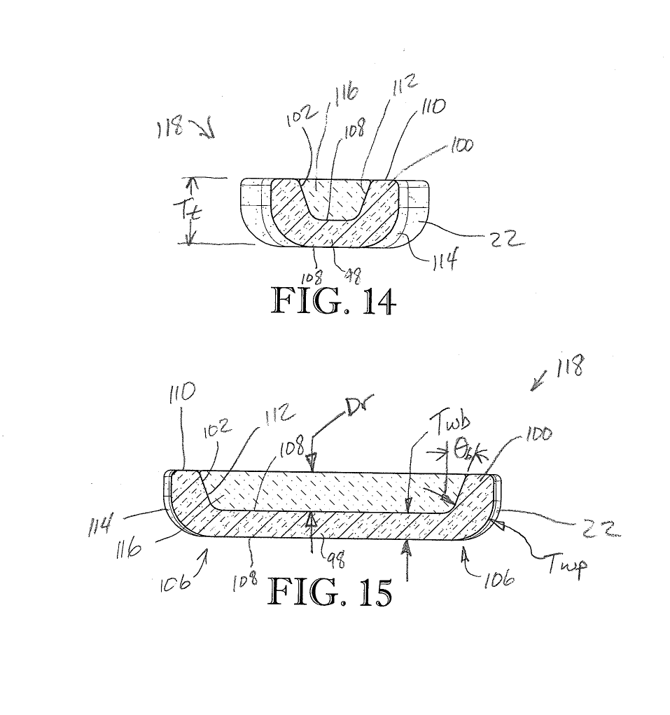

Turning to FIGS. 10-15, the illustrated biscuit maker 20 serves to make multiple foodstuff biscuits 22 for consumption by a pet, such as a dog. The biscuit 22 is preferably unitary and includes a base wall 98 and a peripheral wall 100 that cooperatively define a receptacle opening 102. The walls 98,100 are preferably integrally formed of a foodstuff material and baked to present the unitary biscuit form.

The illustrated biscuit 22 preferably presents a length Lb that ranges from about two (2) inches to about three (3) inches and, more preferably, is about two and one half (2.5) inches (see FIG. 11). The illustrated biscuit 22 also preferably presents a width Wb that ranges from about one (1) inch to about two (2) inches and, more preferably, is about one and one half (1.5) inches.

Prior to baking, the illustrated foodstuff material preferably comprises a dough that includes, among other things, flour and water. However, the principles of the present invention are applicable where the foodstuff material comprises a batter. The foodstuff dough is initially made and rolled into a generally flat and uniform layer of dough (not shown). The layer of dough has a thickness dimension that preferably ranges from about one-quarter (¼) inch to about one-half (½) inch and, more preferably, is about three-eighths (⅜) of an inch.

While the biscuit maker 20 preferably uses a foodstuff material to make pet biscuits, it is within the scope of the present invention where the foodstuff material is alternatively configured, e.g., for making biscuit treats suitable for human consumption. Furthermore, the foodstuff material could be configured to make a treat other than a biscuit. For instance, the foodstuff material could have ingredients such that the baked treat has a relatively softer and/or more flexible consistency, such as a dessert cake.

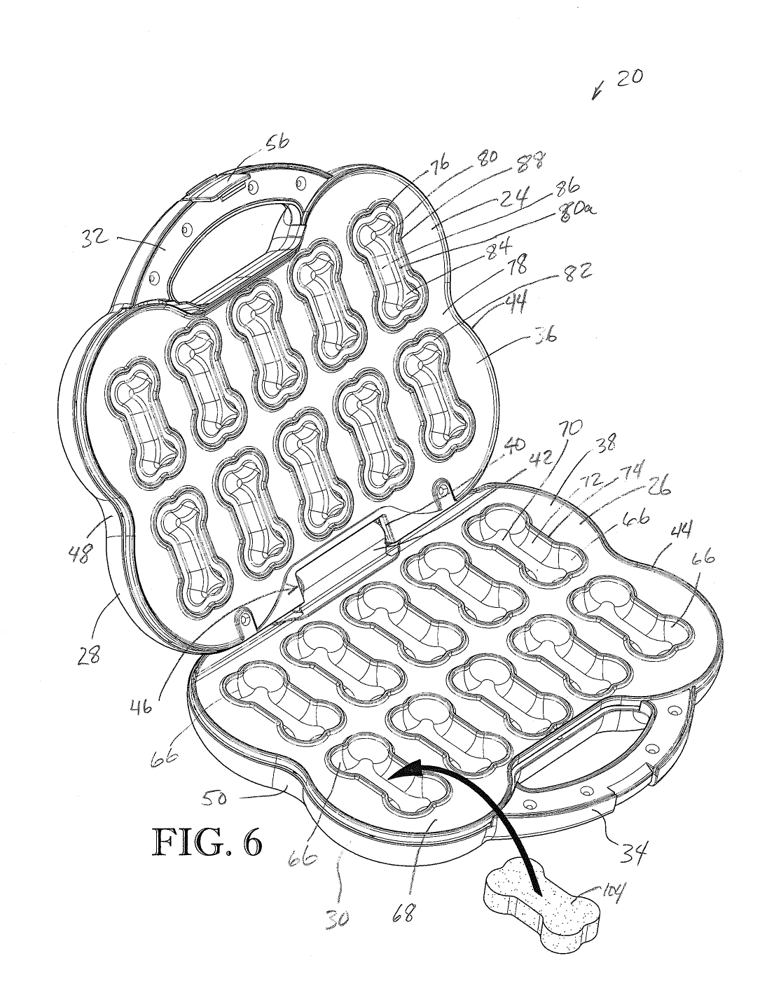

One or more blanks 104 of dough can be cut from the dough layer with a cutting tool (not shown) similar to a conventional cookie cutter. The dough blanks 104 are preferably cut to have a bone-like profile shape that resembles the bone-like profile shape of the cavity (see FIG. 6).

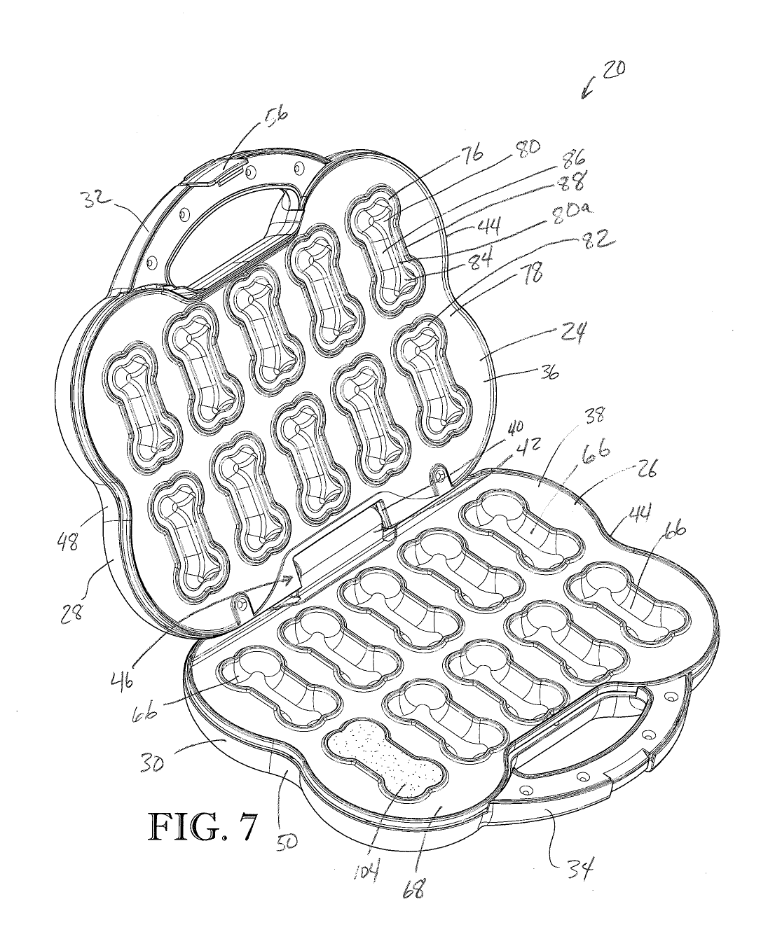

When inserted into the cavity 66, the dough blank 104 preferably extends from a location adjacent the end wall 70 to a location adjacent the lip 74 of the cavity wall 64 (see FIG. 7).

The dough blank 104 preferably substantially fills the biscuit chamber 90 when the dough blank 104 is placed in the cavity 66 of the biscuit maker 20 and the biscuit maker 20 is shifted into the forming position. As the forming plates 24,26 approach the forming position, the protrusion 80 engages the dough blank 104 and begins to push some of the dough in a laterally outboard direction. At the same time, the transverse thickness of the dough blank 104 between the end walls 70,84 is reduced. This shaping of the dough blank 104 by the forming plates 24,26 generally continues as the forming plates 24,26 are brought into the forming position.

The base wall 98 extends laterally to present an outboard margin 106 and opposite laterally extending faces 108. The illustrated faces 108 preferably span the margin 106 and define a transverse wall thickness dimension Twb (see FIG. 15). The transverse wall thickness dimension Twb preferably ranges from about one tenth (0.1) of an inch to about three tenths (0.3) of an inch.

The peripheral wall 100 projects transversely from the outboard margin 106 of the base wall 98 to present a rim 110, with the rim 110 being spaced transversely from the base wall 98. The illustrated peripheral wall 100 preferably tapers toward the rim 110.

The walls 98,100 cooperatively present radially inner and radially outer wall surfaces 112,114 that extend to the rim 110. Along the peripheral wall 100, the radially inner wall surface 112 presents a draft angle dimension θb measured relative to the transverse direction (see FIG. 15). The illustrated draft angle dimension θb preferably ranges from about ten (10) degrees to about thirty (30) degrees and, more preferably, is about twenty (20) degrees. However, it is within the ambit of the present invention where the draft angle dimension θb falls outside of this range. Also, the draft angle dimension θb is preferably substantially continuous along the entire length of the peripheral wall 100.

The base wall 98 and peripheral wall 100 cooperatively define a transverse biscuit thickness dimension Tt. The transverse biscuit thickness dimension Tt is preferably greater than the transverse wall thickness dimension Twb. Also, the transverse biscuit thickness dimension Tt preferably ranges from about four tenths (0.4) of an inch to about five tenths (0.5) of an inch.

The illustrated peripheral wall 100 preferably extends endlessly about the base wall 98 to present the receptacle opening 102. It has been found that this construction is particularly effective for providing the biscuit 22 with suitable strength and rigidity. For instance, the construction of the biscuit 22 reduces the possibility of the biscuit inadvertently falling apart. However, for some aspects of the present invention, the peripheral wall 100 may not be endless. For instance, the biscuit 22 could have a pair of spaced apart peripheral wall sections that extend along the length of the biscuit 22 (e.g., to provide strength and rigidity to the biscuit). Preferably, the base wall 98 spans the receptacle opening 102 so that the walls 98,102 cooperatively form a single continuous receptacle.

The rim 110 and the base wall 98 cooperatively define a receptacle depth dimension Dr measured along the transverse direction (see FIG. 15). The receptacle depth dimension Dr is preferably greater than the transverse wall thickness dimension Twb. Preferably, the receptacle depth dimension Dr ranges from about two tenths (0.2) of an inch to about four tenths (0.4) of an inch and, more preferably, is about three tenths (0.3) of an inch. More preferably, the biscuit 22 defines a ratio of the receptacle depth dimension Dr to the transverse wall thickness dimension Twb that ranges from about 1.5:1 to about 2:1.

The peripheral wall 100 preferably defines a maximum value of a peripheral wall thickness dimension Twp greater than the transverse wall thickness dimension Twb. The peripheral wall thickness dimension Twp is generally measured transverse to the inner wall surface 112 along the peripheral wall 100. Preferably, the transverse wall section thickness dimension Twb ranges from about two tenths (0.2) of an inch to about four tenths (0.4) of an inch and, more preferably, is about three tenths (0.3) of an inch.

Subsequent to baking, the receptacle of the biscuit 22 can be filled with a foodstuff filling 116 to provide a filled biscuit 118. The filling 116 can include various types of foodstuffs in different forms (e.g., a batter, icing, paste, gel, butter, or liquid) without departing from the scope of the present invention.

In operation, the foodstuff dough is initially made and rolled into the generally flat and uniform dough layer. One or more blanks 104 of dough are cut from the dough layer with a cutting tool and are placed in respective cavities 66 when the biscuit maker 20 is open (i.e., when the biscuit maker 20 is shifted out of the forming position).

Prior to inserting the dough blanks 104 in cavities 66, the forming plates 24,26 of the biscuit maker 20 are preferably heated to a predetermined temperature above the ambient temperature. However, the biscuit maker 20 could be heated to the predetermined temperature subsequent to inserting the dough blanks 104.

With the desired number of dough blanks 104 inserted into respective cavities 66, the biscuit maker 20 is shifted into the forming position (see FIGS. 8 and 9). As a result, the dough blanks 104 are shaped to generally have the form of the biscuit 22.

The biscuits 22 are then baked by the biscuit maker 20. Subsequent to baking, the biscuit maker 20 is opened by disengaging the latch 56 and shifting the forming plates 24,26 out of the forming position. The baked biscuits 22 can then be removed from the biscuit maker 20 and allowed to cool. Again, the biscuits 22 can also be filled with the foodstuff filling 116 to provide the filled biscuit 118.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A foodstuff treat maker operable to shape a foodstuff material into a shaped foodstuff treat, said foodstuff treat maker comprising:
a pair of opposed forming plates shiftably attached relative to one another and presenting respective forming surfaces,
one of said forming surfaces defining a protrusion and the other of said forming surfaces defining a cavity,
said pair of forming plates shiftable into and out of a forming position where the forming surfaces are located adjacent and in opposition to one another,
said forming surfaces being shifted away from each other when the forming plates are shifted out of the forming position to expose the forming surfaces and permit the application of foodstuff material to at least one of the forming surfaces,
said protrusion being at least partly received in the cavity in the forming position so that the pair of forming plates are mated with one another, with the mated forming surfaces cooperatively shaping the applied foodstuff material.

2. The foodstuff treat maker as claimed in claim 1,
said forming plates each including a base plate section, with the base plate sections extending adjacent to each other in the forming position,
a first one of the forming plates including a protrusion wall that forms the protrusion, with the protrusion wall being fixed to and extending from a first one of the base plate sections to a protrusion end spaced from the first base plate section,
a second one of the forming plates including a cavity wall that forms the cavity, with the cavity wall being fixed to and extending from a second one of the base plate sections to a cavity end spaced from the second base plate section.

3. The foodstuff treat maker as claimed in claim 2,
said first forming plate including a plurality of protrusion walls that define a plurality of protrusions,
said second forming plate including a plurality of cavity walls that define a plurality of cavities, with each protrusion being at least partly received in a respective one of the cavities in the forming position.

4. The foodstuff treat maker as claimed in claim 2,
said protrusion wall and said cavity wall cooperatively defining a treat chamber in the forming position, with the chamber extending endlessly about the protrusion.

5. The foodstuff treat maker as claimed in claim 4,
said protrusion being spaced entirely from the cavity wall in the forming position.

6. The foodstuff treat maker as claimed in claim 5,
said protrusion end and said cavity wall cooperatively defining a minimum spacing dimension between the protrusion wall and the cavity wall,
said minimum spacing dimension ranging from about one tenth of an inch to about three tenths of an inch.

7. The foodstuff treat maker as claimed in claim 4,
said base plate sections cooperatively defining an overflow chamber in the forming position, with the forming plates operable to permit foodstuff material to flow from the treat chamber to the overflow chamber when an excess foodstuff material restricts the forming plates from shifting into the forming position.

8. The foodstuff treat maker as claimed in claim 4,
said protrusion end and said cavity wall extending laterally adjacent one another in the forming position to define a laterally extending base section of the treat chamber,
said treat chamber including a peripheral section that extends endlessly around and communicates with the base section.

9. The foodstuff treat maker as claimed in claim 8,
said laterally extending base section defining a transverse base thickness dimension in the forming position,
said cavity wall and said protrusion defining a peripheral section thickness dimension greater than the transverse base thickness dimension.

10. The foodstuff treat maker as claimed in claim 8,
said laterally extending base section defining a transverse base thickness dimension in the forming position,
said protrusion wall including a base wall that interconnects the protrusion and the respective base plate section.
said base wall and said protrusion end cooperatively defining a transverse protrusion depth dimension,
said transverse protrusion depth dimension being greater than the transverse base thickness dimension.

11. The foodstuff treat maker as claimed in claim 10,
said maker defining a ratio of the transverse protrusion depth dimension to the transverse base thickness dimension that ranges from about 1.5:1 to about 2:1.

12. The foodstuff treat maker as claimed in claim 1,
one of said pair of forming plates including a base plate section and the protrusion, with the protrusion extending from adjacent the base plate section to a protrusion end spaced from the base plate section,
said protrusion including side walls that taper toward the protrusion end.

13. The foodstuff treat maker as claimed in claim 1,
said protrusion and said cavity cooperatively defining a treat chamber in the forming position, with the chamber extending endlessly about the protrusion.

14. The foodstuff treat maker as claimed in claim 13,
said protrusion being spaced from the cavity in the forming position.

15. The foodstuff treat maker as claimed in claim 14,
said protrusion and said cavity cooperatively defining a minimum spacing dimension that ranges from about one tenth of an inch to about three tenths of an inch.

16. The foodstuff treat maker as claimed in claim 1; and
a heating element operable to be powered to provide heat,
said heating element mounted adjacent to and operable to heat at least one of the plates.

17. A baked foodstuff biscuit comprising:
a base wall and a peripheral wall integrally formed of a foodstuff material and baked with each other to present a unitary biscuit form,
said base wall extending laterally to present an outboard margin and opposite laterally extending faces that span the margin and define a transverse wall thickness dimension,
said peripheral wall projecting transversely from the outboard margin of the base wall so that the base wall and peripheral wall cooperatively define a transverse biscuit thickness dimension greater than the transverse wall thickness dimension,
said peripheral wall extending endlessly about the base wall to present a biscuit opening, with the base wall spanning the biscuit opening so that the walls cooperatively form a receptacle opening.

18. The baked foodstuff biscuit as claimed in claim 17,
said peripheral wall defining a maximum peripheral wall thickness dimension greater than the transverse wall thickness dimension.

19. The baked foodstuff biscuit as claimed in claim 18,
said peripheral wall presenting a rim spaced transversely from the base wall, with the peripheral wall tapering toward the rim.

20. The baked foodstuff biscuit as claimed in claim 19,
said peripheral wall presenting a radially inner wall surface,
said radially inner wall surface presenting a draft angle dimension measured relative to the transverse direction,
said draft angle dimension ranging from about ten degrees to about thirty degrees.

21. The baked foodstuff biscuit as claimed in claim 20,
said draft angle dimension being substantially continuous along the entire length of the peripheral wall.

22. The baked foodstuff biscuit as claimed in claim 19,
said rim and said base wall cooperatively defining a receptacle depth dimension of the receptacle opening,
said receptacle depth dimension being greater than the transverse wall thickness dimension.

23. The baked foodstuff biscuit as claimed in claim 22,
said biscuit defining a ratio of receptacle depth dimension to transverse wall thickness dimension that ranges from about 1.5:1 to about 2:1.
